(19) United States
(12) Patent Application Publication
(10) Pub. No.: US 2013/0110690 A1
(43) Pub. Date: May 2, 2013

(54) SYSTEMS AND METHODS FOR TRANSACTION ACCOUNT CUSTOMER ACQUISITION, ENROLLMENT, AND MANAGEMENT

(71) Applicants: Hans-Jurgen Greiner, Desert Hills, AZ (US); Robert Mawk, Phoenix, AZ (US); Jack Romanowicz, Tempe, AZ (US); Sarah Shumway, Glendale, AZ (US); Sundhar Subramanian, Phoenix, AZ (US)

(72) Inventors: Hans-Jurgen Greiner, Desert Hills, AZ (US); Robert Mawk, Phoenix, AZ (US); Jack Romanowicz, Tempe, AZ (US); Sarah Shumway, Glendale, AZ (US); Sundhar Subramanian, Phoenix, AZ (US)

(73) Assignee: American Express Travel Related Services Company, Inc., New York, AZ (US)

(21) Appl. No.: 13/282,169

(22) Filed: Oct. 26, 2011

(51) Int. Cl. G06Q 40/02

(52) U.S. Cl. 705/35

(57) ABSTRACT

A system, method, and article of manufacture for transaction account customer acquisition, enrollment, and management is disclosed. The method may comprise receiving a transaction account application, receiving a username and password, creating an account management system (“AMS”) account based upon the username and password, and associating the AMS account with the transaction account application. The method may further comprise requesting information and/or a document from a user associated with the transaction account application, wherein the user's transaction account application is pending. Further still, the method may variously comprise receiving information and/or a document from a user associated with the transaction account application in response to a deficiency associated with the transaction account application.

### BACKGROUND

1. Field

The present disclosure generally relates to transaction account customer acquisition, enrollment, and management. More particularly, the present disclosure relates to improved systems and methods for communicating with transaction account applicants.

2. Related Art

Traditionally, transaction account applicants are driven to a web-based interface for managing their transaction or “card” accounts only in response to approval of their applications for such accounts (e.g., applications for credit and/or debit accounts). This gap between an applicant's application for an account and the date on which the account is approved is therefore unused and may leave an applicant feeling confused, as well as generally excluded from the application process.

It would be advantageous to develop a system and method for communicating with a transaction account applicant, prior to approval of the applicant's transaction account. Further, and for example, a system and method for communicating updates, requests for information, responses to requests for information, offers, counteroffers, and the like would be advantageous if provided during the waiting period between application submission and application approval (i.e., during an application processing interval or “pendency” of the application).

### SUMMARY

The present disclosure includes a system, method, and article of manufacture for transaction account customer acquisition, enrollment, and management. The method may comprise receiving a transaction account application, receiving a username and password, creating an account management system (“AMS”) account based upon the username and password, and associating the AMS account with the transaction account application. In various embodiments, the method may further comprise requesting information and/or a document from a user associated with the transaction account application, wherein the user's transaction account application is pending. Further still, the method may variously comprise receiving information and/or a document from a user associated with the transaction account application, in response to a deficiency associated with the transaction account application.

In various embodiments, the method may also comprise transmitting a counteroffer to a user associated with the transaction account application based upon the transaction account application and via the AMS account. The method may also comprise receiving preference data from a user associated with the transaction account application, and via the AMS account, during pendency of the transaction account application. Further, the method may comprise relocating information associated with the AMS account, in response to approval of the transaction account application, and/or relocating preference data in response to approval of the transaction account application.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1 shows an exemplary system diagram in accordance with various embodiments.

FIG. 2 shows a flowchart depicting an exemplary process for transaction account customer acquisition, enrollment, and management.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

As used herein, “transmit” may include sending electronic data from one system component to another over a network connection. Additionally, as used herein, “data” may include encompassing information such as commands, queries, files, data for storage, and the like in digital or any other form.

Phrases and terms similar to “account” or “transaction account” may include any account that may be used to facilitate a financial transaction. A transaction account may include an account, as described herein.

As used herein, a “transaction account application,” or an “application” may include any application for any type of transaction account. For example, a transaction account application may comprise an application for a credit account and/or a debit account (e.g., a checking or debit account).

As used herein, a “transaction account applicant” may comprise an individual or a “user” who applies for a transaction account and/or who submits a transaction account application.

As used herein, a “user” may comprise any individual, group, entity, organization machine, hardware, software and/or business. For instance, a “user” may comprise any individual who interfaces with a system for transaction account customer acquisition, enrollment, and management (e.g., system 100).

Phrases and terms similar to “account number”, “account code,” “consumer account,” and/or “transaction account number,” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

An account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

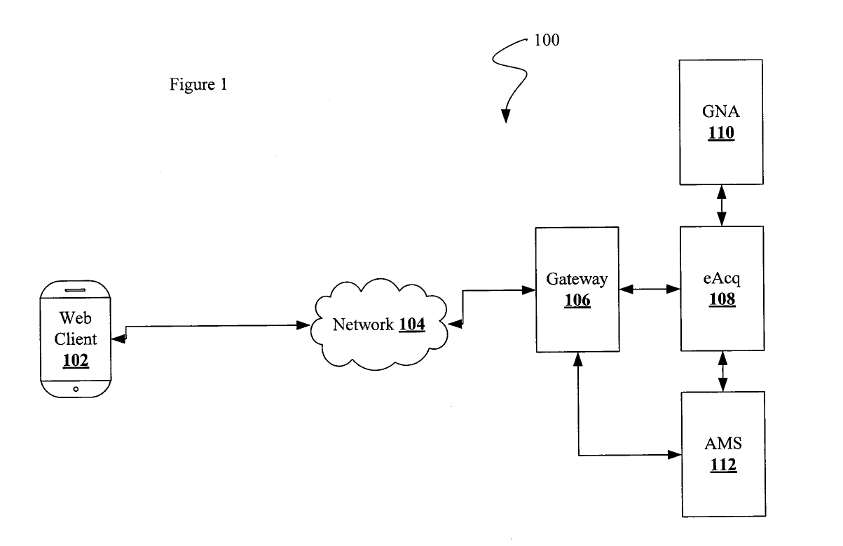

A system for transaction account customer acquisition, enrollment, and management is disclosed. In one exemplary embodiment, a system for communicating with transaction account applicants during an application processing interval is disclosed. Referring to FIG. 1, an exemplary system 100 for transaction account customer acquisition, enrollment, and management is disclosed.

System 100 may comprise a web client 102, a network 104, a gateway 106, a global new accounts system (GNA) 108, an electronic acquisition system (eAcq) 110, and an account management system (AMS) 112.

A web client 102 may include any device (e.g., personal computer) which communicates via any network, for example such as those discussed herein. A web client 102 may include one or more browser applications and/or application programs, including browser applications comprising Internet browsing software installed within a computing unit or a system to conduct online transactions and/or communications. For example, in various embodiments, a web client 102 may include (and run) Microsoft Internet Explorer, Mozilla Firefox, Google Chrome, Apple Safari, and/or any of the other myriad software packages available for browsing the Internet.

A computing unit or system may take the form of a computer or set of computers, although other types of computing units or systems may be used, including tablets, laptops, notebooks, hand held computers, personal digital assistants, cellular phones, smart phones, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. The computing unit of the web client 102 may be further equipped with an Internet browser connected to the Internet or an intranet using standard dial-up, cable, DSL or any other Internet protocol known in the art. Transactions originating at a web client 102 may pass through a firewall in order to prevent unauthorized access from users of other networks. Further, additional firewalls may be deployed between the varying components of system 100 to further enhance security.

A web client 102 may or may not be in direct contact with an application server. For example, a web client 102 may access the services of an application server through another server and/or hardware component, which may have a direct or indirect connection to an Internet server. For example, a web client 102 may communicate with an application server via a load balancer. In an exemplary embodiment, access is through a network or the Internet through a commercially-available web-browser software package.

A web client 102 may further include an operating system (e.g., Windows NT, 95/98/2000/CE/Mobile, OS2, UNIX, Linux, Solaris, MacOS, PalmOS, etc.) as well as various conventional support software and drivers typically associated with computers. A web client 102 may be in a home or business environment with access to a network. A web client 102 may implement security protocols such as Secure Sockets Layer (SSL) and Transport Layer Security (TLS). A web client 102 may further implement several application layer protocols including http, https, ftp, and sftp.

A network 104 may include any electronic communications system or method which incorporates hardware and/or software components (e.g. a “cloud” or “cloud computing” system, as described herein). Communication among parties via a network 104 may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system 100 is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network 104 is in the nature of a public network, such as the Internet, it may be advantageous to presume the network 104 to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network 104 via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network 104 may be implemented variously, such as, for example, as an interactive television (ITV) network. Moreover, this disclosure contemplates the use, sale or distribution of any goods, services or information over any network having similar functionality described herein.

“Cloud” or “Cloud computing” may comprise a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

A gateway 106 may comprise any system or systems capable of communicating with one or more other systems over a network 104. For example, a gateway 106 may comprise a three-tiered web-based architecture, including one or more web servers, one or more application servers, and/or one or more databases. A gateway 106 may, in various embodiments, communicate over a network 104 with one or more web clients 102, one or more eAcq systems 108, one or more GNAs 110, and/or one or more AMSes 112. A gateway 106 may further serve and/or provide content (e.g., web pages and/or other web-based content) to a web client 102 and/or receive communications and/or information from a web client 102, a GNA 110, an eAcq 108, and/or an AMS 112.

eAcq 108 may comprise any system or systems capable of communicating over a network 104 with a web client 102 to process a transaction account application. For example, and in various embodiments, eAcq 108 may comprise a computer-based system configured or configurable to communicate with a web client 102 (e.g., through gateway 106) to acquire a transaction account application. eAcq 108 may further communicate with AMS 112 to store and manage one or more user preferences, transaction account data, and the like. In various embodiments (e.g., where a transaction account application is pending approval), eAcq 108 may act as a communication channel between GNA 110 and AMS 112. That is, eAcq 108 may facilitate communications between GNA 110 and AMS 112.

A GNA 110 may comprise any system or systems capable of receiving, storing, and/or processing one or more applications for one or more transaction accounts (i.e., one or more transaction account applications). For example, GNA 110 may comprise a computer-based system configured or configurable to process one or more applications for one or more new transaction accounts. GNA 110 may approve or decline an application for a new transaction account based upon one or more business rules. GNA 110 may decline a particular transaction account application, but offer to approve or process a different transaction account and/or transaction account type and/or transaction account having a different (e.g., lower or higher) spending limit, etc. Thus, in various embodiments, GNA 110 may make or transmit a counteroffer based in response to a transaction account application that cannot or should not be approved based upon the business rules.

AMS 112 may comprise any system or systems capable of receiving, storing, and/or processing user information. For example, in various embodiments, AMS 112 may comprise a computer-based system configured or configurable to receive, process, and/or store transaction account information, transaction account settings, and the like. More particularly, and in various embodiments, AMS 112 may receive, process, and/or store requested documents (e.g., documents requested by GNA 110 for processing a transaction account application), information requests, account settings and/or preferences (e.g., a preference for paperless statement delivery), and the like. AMS 112 may also, and again, in various embodiments, generate and/or communicate one or more offers, rewards points, account information (e.g., status information, such as billing cycle data and payment information), one or more counteroffers (as described elsewhere herein), and the like. Further, in various embodiments, AMS 112 may perform automated virus scans on uploaded documents and/or other data. AMS 112 may further provide a bi-directional mailbox and/or a uni-directional mailbox, with which a user may communicate with GNA 110 and/or a customer service representative regarding, among other things, the status of a pending transaction account application.

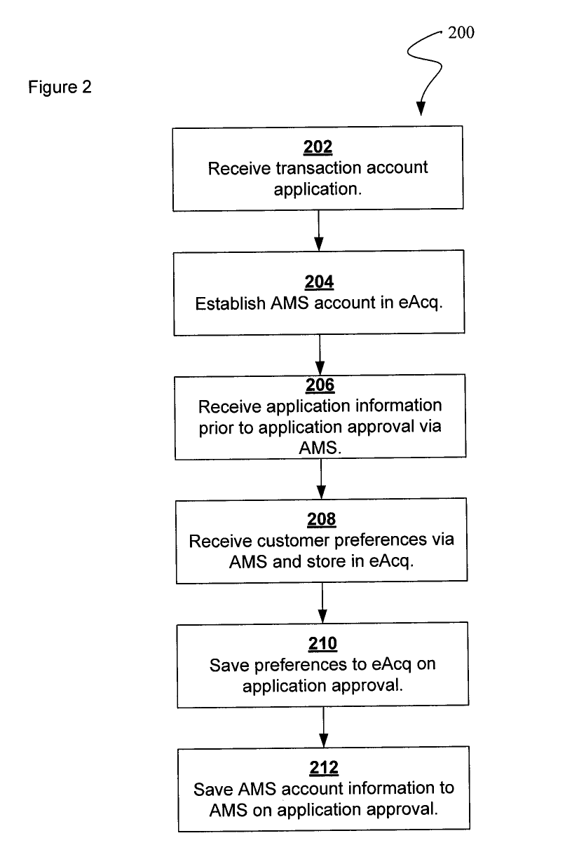

Referring now to FIG. 2, the process flow depicted is merely an embodiment and is not intended to limit the scope of the disclosure. For example, the steps recited in any of the method or process descriptions may be executed in any order and are not limited to the order presented. It will be appreciated that the following description makes appropriate references not only to the steps and user interface elements depicted in FIG. 2, but also to the various system components as described above with reference to FIG. 1.

With specific reference to FIG. 2, a process 200 for customer acquisition, enrollment, and management is shown. A user (e.g., an individual who is interested in acquiring or applying for a transaction account) may submit a transaction account application by way of a web client 102, by mail, by telephone, etc. An application may be forwarded or transmitted to GNA 110, which may, as described elsewhere herein, process the application based upon one or more business rules (step 202).

In response to submitting a transaction account application, a user may be prompted (e.g., by GNA 110, eAcq 108 and/or AMS 112) to establish an account with AMS 112 (or an “AMS account”) (step 204). An AMS account may be associated with or linked to a transaction account application; and, this association may be stored in eAcq 108 and/or GNA 110, and/or AMS 112. In various embodiments, and as described elsewhere herein, an association between an AMS account and a transaction account application may be stored in eAcq 108 prior to application approval and in AMS 112 after application approval. A user's AMS account may further comprise a username and/or password. In various embodiments, a user's AMS account may further comprise a biometric identifier, which may be used to authenticate the user in conjunction with a biometric sample provided by the user during a login attempt.

Thus, a user may communicate with system 100 (e.g., GNA 110, eAcq 108 and/or AMS 112) using his AMS account, both during the pendency of the user's transaction account application (i.e., while GNA 110 processes the application and prior to application approval) as well as after the user's application has been approved or denied. It is therefore an advantage of system 100 that, although in the past, users have been required to wait until transaction account application approval to communicate with system 100, they may, using the system 100 and methods described herein, communicate and interact with system 100 (e.g., GNA 110, eAcq 108, and/or AMS 112) during the pendency of their transaction account applications.

In terms of the communication that may occur between a user and system 100, and for example, a user who has submitted a transaction account application for approval by GNA 110 may receive (by way of his AMS account and/or web client 102) an information and/or document request (e.g., follow up questions) from GNA 110 (step 206). For instance, a user who has filled out a transaction account application but has nevertheless failed to supply all of the information requested or required by the application may receive an information and/or document request from GNA 110 to supplement his application with missing or additional information. Thus, a user may receive a request for information based upon a deficiency in the user's application. In various embodiments, and for purposes of illustration, a user may receive requests for information and/or documents related to the user's residential history and/or the user's credit history. A user may likewise receive a request for information related to a particular document and/or a request that the user upload or otherwise provide a particular document (e.g., a bank account statement or tax return).

In various embodiments, a user may use his AMS account and/or web client 102 to take advantage of “forgot password” and/or “forgot userid” features, which, in the past, may have only been available to existing transaction account customers. Further, during an authentication and/or login process, a user (whether his application has been approved, is pending, or has been denied) may be required to authenticate to system 100 based upon a variety of personally identifying information (e.g., name, birthdate, mother's maiden name, address, etc.), which the user may have provided via his transaction account application.

In response to receiving a request for information and/or a request for one or more documents, a user may submit or upload the requested information and/or requested documents via his AMS account and/or his web client 102. For example, where GNA 110 requests information, a user may log into his AMS account and enter this information via an interface provided or displayed by his web client 102. Similarly, where a user receives a request for a document, the user may log into his AMS account, again via an interface provided or displayed by his web client 102, and upload the requested document, which may be transmitted via gateway 106 to GNA 110 for further processing. In various embodiments, a document may be uploaded in a variety of formats. For instance, a document may be uploaded in .pdf, .gif, .jpg, .tiff, .xls, .doc., .rtf, .png, and the like. Further, in various embodiments, a document may be subject to a virus scan during and/or following an upload process. A user may be notified of a successful or unsuccessful document upload and/or download (e.g., due to the results of a virus scan, due to a network problem or event, etc.), and provided an opportunity to repeat the failed operation.

Various embodiments may, in addition, feature a bi-directional mailbox and/or a uni-directional mailbox (broadly, a “mailbox”) with which a user may communicate with a customer service representative regarding his application (or for any other reason). A bi-directional mailbox may comprise a mailbox or electronic message center into which both a user and a customer service representative (or another party) may place or save messages and/or other communications. A uni-directional mailbox may likewise comprise a mailbox or an electronic message center into which either a user or a customer service representative (or another party) may place of save messages and/or other communications, but not both. A user's mailbox may be displayed via a web client 102. Although a mailbox may not be necessary for communication (e.g., of documents and information) between a user and system 100, in various embodiments, a user may upload and/or download documents to and/or from his mailbox as well as receive and or submit information and/or information requests to and/or from his mailbox. In various embodiments, including where a mailbox is employed for the purpose of communicating with an applicant, communications may be handled securely (e.g., encrypted, via SSL, TSL, and the like).

Further still, and in various embodiments, a user may receive one or more offers, rewards points, account information (e.g., status information, such as billing cycle data and payment information), one or more counteroffers, and the like via system 100. Where a user receives a counteroffer, this may occur in response to, for example, a determination by GNA 110 that the user's transaction account application should not be approved absent a modification of some type—e.g., a type modification, a spending limit modification, and/or the like. As described elsewhere herein, GNA 110 may base a determination of this nature on one or more business rules. For instance, GNA 110 may determine, based upon a user's application, that the user has insufficient credit history or an insufficient credit rating to warrant approval of a transaction account that has been applied for by the user. Where GNA 110 makes this determination, GNA 110 may transmit a second account offer or a counteroffer to the user, in which the user may be offered, for example, a transaction account having a lower spending limit.

Thus, it is a further advantage of system 100 that a success rate associated with transaction account applications (i.e., a rate of transaction account application approval) may be increased, particularly over a success rate associated with older systems in which an applicant is not granted access (as he may be with system 100) to his transaction account application and/or to the details of the processing of his account application. This may be accomplished, as described elsewhere herein, by virtue of the user's ability to log in to system 100 and to communicate with system 100 during the pendency of his transaction account application. That is, a user may receive offers, counteroffers, a user may provide supplemental information and/or supplemental documentation, and each of these factors may contribute, alone and/or in combination, to the success rate with which new applications are approved and potential customers converted to transaction account customers. That is, system 100 may enhance a success rate associated with transaction account customer acquisition and enrollment, and may offer features, as described throughout, for transaction account customer and/or application management.

In a variety of embodiments, a user may set or select one or more customer preferences and/or account settings during (and after) the pendency of a transaction account application (step 208). For instance, a user may select an option to receive paperless statements, an option to receive alerts, an option to enroll in a pay by personal computer feature, and the like. Further, in various embodiments, a user may deselect each of these options. Further still, and particularly where a user's transaction account application has not been approved, a user may login to his AMS account to select from a variety of aesthetic options which may be associated with his account. These may include, for example, a color and/or print associated with the user's transaction account instrument, a color and/or print (e.g., a “skin”) associated with the user's web client 102 browser interface to AMS 112, and the like. Each of these options may further increase a success rate associated with the acquisition and enrollment of transaction account applications, as described elsewhere herein.

System 100 may relocate a variety of user data (e.g., AMS account data, preference data, application data, and the like) in response to approval by GNA 110 of a user's transaction account application. For example, a user's AMS account information (e.g., an association or link between the user's AMS account and the user's transaction account application) may be stored in eAcq 108 during the pendency of the user's application, but transferred to storage in AMS 112 in response to approval by GNA 110 of the user's application (step 210). This reorganization of AMS account data may improve a speed and/or an efficiency associated with an AMS account login and management process. That is, for example, after approval of a transaction account user's application, the user's account may be transferred to AMS 112, which may communicate directly (as opposed to through eAcq 108) through network 104 and/or gateway 106 with the user's web client 102. Likewise, a user's preference data (e.g., a user's preference for paperless billing and/or alerts) may be transferred from AMS 112 (where it was stored prior to application approval) to eAcq 108 in response to approval by GNA 110 of the user's transaction account application (step 212). As described above, this reorganization of data may improve a speed and/or an efficiency associated with the operation of system 100 (e.g., system 100 may avoid querying AMS 112 for preference data).

Thus, system 100 offers a variety of features and advantages over prior art systems. For example, system 100 may permit a transaction account applicant to establish an AMS account during the pendency of his transaction account application. This may, in itself or in combination with a variety of features and advantages offered by AMS 112 (e.g., options to communicate with GNA 110 to provide information and/or documents, options to set preferences and/or alerts, and the like) may increase both user satisfaction as well as the success rate associated with the enrollment, acquisition, and management of transaction account users. In achieving these advantages, system 100 may further organize and reorganize a variety of data based upon an applicant's status as an approved applicant and/or a pending applicant; and this organization and reorganization may permit, first, creation of an AMS account for a transaction account applicant and, second, efficiency and operational speed at both stages of the application process (e.g., pendency and approval or denial).

In various embodiments, GNA 110 may be unable to approve an application, because of the necessity of verifying an applicant's identity. For example, in various embodiments, GNA 110 may be unable to verify an applicant's identity, which may forestall approval of the applicant's application. Where this is the case, AMS 112 may communicate with GNA 110 to obtain verification questions from a credit reporting bureau (e.g., TransUnion®). And, these verification questions may be presented by system 100 to an applicant via the applicant's web client 102. Answers from the applicant may be received by AMS 112 and transmitted to GNA 110, which may, in turn, transmit the answers to the credit reporting bureau. The credit reporting bureau may, in response to receiving an applicant's answers to verification questions, may check the applicant's answers against a stored copy of the applicant's earlier answers and/or an independently derived and/or gathered copy of answers to the verification questions. Thus, an applicant's identity may be verified, and the applicant's application further processed. This feature, where it is included, may thus allow for self-servicing by an applicant of an identity verification requirement (as opposed to requiring intervention and/or assistance by a customer service representative or agent). Thus, in various embodiments, applicant satisfaction and engagement with system 100 may be improved.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers. A user may include any individual, business, entity, government organization, software and/or hardware that interact with a system.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, “issue a debit”, “debit” or “debiting” refers to either causing the debiting of a stored value or prepaid card-type financial account, or causing the charging of a credit or charge card-type financial account, as applicable.

Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

A firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program, instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

The system may include or interface with any of the foregoing accounts or devices, a transponder and reader in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

What is claimed is:

1. A method comprising:
receiving, by a transaction account computer-based system, a transaction account application;
receiving, by the computer-based system, a username and password;
creating, by the computer-based system, an account management system (“AMS”) account based upon the username and password; and
associating, by the computer-based system, the AMS account with the transaction account application.

2. The method of claim 1, further comprising requesting, by the computer-based system, at least one of information and a document from a user associated with the transaction account application, wherein the user's transaction account application is pending.

3. The method of claim 1, further comprising receiving, by the computer-based system, at least one of information and a document from a user associated with the transaction account application in response to a deficiency associated with the transaction account application.

4. The method of claim 1, further comprising transmitting, by the computer-based system, a counteroffer to a user associated with the transaction account application based upon the transaction account application and via the AMS account.

5. The method of claim 1, further comprising receiving, by the computer-based system, preference data from a user associated with the transaction account application, and via the AMS account, during pendency of the transaction account application.

6. The method of claim 1, further comprising relocating, by the computer-based system, information associated with the AMS account, in response to approval of the transaction account application.

7. The method of claim 1, further comprising relocating, by the computer-based system, preference data in response to approval of the transaction account application.

8. A system comprising:
a transaction account processor;
a tangible, non-transitory memory communicating with the processor;
the tangible, non-transitory memory having instructions stored thereon that, in response to execution by the processor, cause the processor to perform operations comprising:
receiving, by the processor, a transaction account application;
receiving, by the processor, a username and password;
creating, by the processor, and account management system (“AMS”) account based upon the username and password; and
associating, by the processor, the AMS account with the transaction account application.

9. The system of claim 8, further comprising requesting, by the processor, at least one of information and a document from a user associated with the transaction account application, wherein the user's transaction account application is pending.

10. The system of claim 8, further comprising receiving, by the processor, at least one of information and a document from a user associated with the transaction account application in response to a deficiency associated with the transaction account application.

11. The system of claim 8, further comprising transmitting, by the processor, a counteroffer to a user associated with the transaction account application based upon the transaction account application and via the AMS account.

12. The system of claim 8, further comprising receiving, by the processor, preference data from a user associated with the transaction account application, and via the AMS account, during pendency of the transaction account application.

13. The system of claim 8, further comprising relocating, by the processor, information associated with the AMS account in response to approval of the transaction account application.

14. The system of claim 8, further comprising relocating, by the processor, preference data in response to approval of the transaction account application.

15. An article of manufacture including a non-transitory, tangible computer readable medium having instructions stored thereon that, in response to execution by a transaction account computer-based system, cause the computer-based system to perform operations comprising:
receiving, by the computer-based system, a transaction account application;
receiving, by the computer-based system, a username and password;
creating, by the computer-based system, and account management system (“AMS”) account based upon the username and password; and
associating, by the computer-based system, the AMS account with the transaction account application.

16. The article of claim 15, further comprising requesting, by the computer-based system, at least one of information and a document from a user associated with the transaction account application, wherein the user's transaction account application is pending.

17. The article of claim 15, further comprising receiving, by the computer-based system, at least one of information and a document from a user associated with the transaction account application in response to a deficiency associated with the transaction account application.

18. The article of claim 15, further comprising transmitting, by the computer-based system, a counteroffer to a user associated with the transaction account application based upon the transaction account application and via the AMS account.

19. The article of claim 15, further comprising receiving, by the computer-based system, preference data from a user associated with the transaction account application, and via the AMS account, during pendency of the transaction account application.

20. The article of claim 15, further comprising relocating, by the computer-based system, information associated with the AMS account in response to approval of the transaction account application.
